(19) United States
(12) Patent Application Publication
(10) Pub. No.: US 2022/0323887 A1
(43) Pub. Date: Oct. 13, 2022

(54) MODULE CARRIER FOR USE IN A SYSTEM FOR MONITORING AND TREATING FLUID MEDIA

(71) Applicant: ProMinent GmbH, Heidelberg (DE)

(72) Inventors: Manfred GRIMM, Plankstadt (DE); Michael WITTKAMPF, Oftersheim (DE); Thomas WINKLER, Karlsruhe (DE)

(73) Assignee: ProMinent GmbH, Heidelberg (DE)

(21) Appl. No.: 17/716,906

(22) Filed: Apr. 8, 2022

(30) Foreign Application Priority Data
Apr. 12, 2021 (DE) 102021109094.6

(51) Int. Cl. B01D 35/30; C02F 1/00

(52) U.S. Cl. CPC B01D 35/303; C02F 1/001; B01D 2201/347; C02F 2201/007; C02F 2301/043

(57) ABSTRACT

Module carrier for receiving a module having a fluid connection for use in a system for water treatment or water monitoring, wherein the module carrier can be reversibly connected to at least one further module carrier to form a module carrier assembly, wherein the module carriers can be connected to one another mechanically and detached from one another, wherein, during the mechanical separation or connection of the module carriers, at least one hydraulic connection between the module carriers can likewise be separated or connected.

### CROSS REFERENCE TO RELATED APPLICATION

This patent application is a national stage application of DE 10 2021 109 094.6, filed on Apr. 12, 2021, the disclosure of which is incorporated by reference herein in its entirety.

### TECHNICAL FIELD

The present invention relates to a module carrier for receiving a module having a fluid connection for use in a system for treating or monitoring fluid media. The module carrier can be connected to at least one further module carrier to form a module carrier assembly.

### BACKGROUND

DE 10 2017 116 269 discloses a modular sensor arrangement having a fitting, a shaft and a line, arranged within the fitting, for carrying a free-flowing medium, wherein an end section of the line opens into the shaft. A sensor which is suitable for determining or monitoring a process variable of the free-flowing medium can be inserted into the shaft. At its end section opening into the shaft, the line has a replaceable nozzle, wherein the flow into the sensor can be adjusted by means of the configuration and/or the alignment of the nozzle.

Modular systems for water treatment are known from the White Paper: Anlagen nach dem Lego-Prinzip—Modulare Automation mit Ventilinseln [Systems on the Lego Principle—Modular Automation with Valve Clusters] (https://www.festo.com/net/SupportPortal/Files/374864/WhitePaper_Ventilinseln_de_V06_L.pdf). Each module provides its specific functionality encapsulated at a data interface, i.e. type of operation, status, process measured values, alarms and other properties can be read/written after modules have been interconnected to form a technical process system, in order thus to implement the functionality of the overall system. The sensors are firmly connected to the line of the free-flowing medium. The measurement module and the feed of the fluid medium are always combined in one unit.

The systems known from the prior art for determining or monitoring a process variable of a free-flowing medium do not yet fulfill all the requirements on such systems with regard to the ability to be constructed and expanded easily in a satisfactory way, however.

### SUMMARY

The object of the present invention was, therefore, to provide module carriers for use in systems for monitoring and treating fluid media in which, firstly, the module carriers can be connected to further module carriers and, secondly, the module carrier is set up for the reversible mechanical connection or separation of the module carrier to or from the module arranged thereon.

According to the invention, this object is achieved by the module carrier according to claim 1.

Preferred embodiments of the invention can be gathered from the subclaims and the following detailed description.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 depicts an illustrative cross-sectional view of the module carrier, according to one or more embodiments described.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

The terms “up” and “down”; “upward” and “downward”; “upper” and “lower”; “upwardly” and “downwardly”; “above” and “below”; and other like terms as used herein refer to relative positions to one another and are not intended to denote a particular spatial orientation since the apparatus and methods of using the same may be equally effective at various angles or orientations.

The subject of the present invention is accordingly a module carrier for receiving a module having a fluid connection for use in a system for treating or monitoring a fluid medium, which can be reversibly connected to at least one further module carrier to form a module carrier assembly. During the separation or connection of a plurality of module carriers, at least one hydraulic connection between two module carriers can be separated or connected.

The module carrier according to the invention is set up for the mechanical connection and separation from the module assigned to it, wherein at least one hydraulic connection between the module carrier and the module can be separated or connected during the separation or connection of the module carrier and the module.

In principle, liquid or gaseous media are considered as fluid media. The module carriers according to the invention are suitable in particular for liquid fluid media. The liquid fluid medium is in principle subjected to no restriction per se. Merely by way of example, mention should be made here of organic or inorganic liquids which, for example, can be used as solvents or lubricants and during the application of which process variables of the liquid must be determined, monitored or adjusted, which is achieved by the modules which are arranged on the module carriers according to the invention.

A particularly preferred fluid medium is water; in this case, the various modules are generally used for the analytical determination of parameters of the water in line systems such as, for example, process water lines, drinking water lines or wastewater lines.

The module carriers according to the invention are preferably used in so-called bypass fittings. A bypass fitting is incorporated in a bypass line of the main process line. The bypass line permits the controlled removal of part of the fluid medium in the main line via a suitable device for controlling the quantity of the partial stream removed. Thus, it becomes possible to determine, to monitor or to control process variables during continuous operation without the main stream of the fluid medium being impaired.

Through the bypass line, the free-flowing medium to be measured reaches the bypass fitting, in which fitting the fluid medium flows through mobile carriers according to the invention having sensor modules arranged thereon. After flowing through the last module in the direction of flow, the fluid medium examined can be discharged or fed back into the process.

Preferably, the module carriers according to the invention are designed with a flat outline, which has a largest-area main surface and wherein the hydraulic connections between the module carriers are arranged on side surfaces which adjoin the main surface.

According to a preferred embodiment of the invention, the module carrier according to the invention has a hydraulic connection each on mutually opposite side surfaces, by which means at least two module carriers can be connected to each other in series. Given such a configuration, each module carrier can be connected to each adjacent module carrier by exactly one hydraulic connection.

The hydraulic connection between two module carriers or between the module carrier and module can preferably be produced without any tools, for example by plugging, a screw closure or a bayonet fitting, to name only three examples. The person skilled in the art will select the best suitable type of connection in the practical application with the aid of their general expertise while taking into account the requirements of the practical situation, so that more detailed explanations are unnecessary at this point.

The module carriers are or can also be connected to one another or to the modules mechanically. This secures the hydraulic connection

Here, a mechanical connection is to be understood to be a connection with which two module carriers or a module and a module carrier are connected mechanically in such a way that a relative movement of the connected module carriers or a relative movement of the module carrier and module is prevented.

Suitable means for producing a mechanical connection are, for example, screw connections. In principle, however, other means for mechanical connections known to those skilled in the art are also suitable, so that there are no particular restrictions at this point.

The hydraulic connection between the module carrier and module is preferably likewise configured with a sealing device, which preferably seals as a result of pressure in the connection direction.

Preferably, pressure for the sealing device can also be generated by the aforementioned mechanical connection.

The invention also relates to a module carrier device having a plurality of module carriers according to the invention, wherein a hydraulic connection between two module carriers is configured with a sealing device, wherein the sealing device preferably seals radially and/or the sealing device is preferably designed to seal off in various positions in the connection direction of the hydraulic connection.

According to one embodiment of the invention, in a module carrier device according to the invention, the mechanical connection can be effected via a screw connection, wherein pressure for the sealing device can in particular be generated by the mechanical connection.

The module is preferably set up on the module carrier such that two hydraulic connections between the module carrier and module are produced and it is thus ensured that the free-flowing medium flows into the module through one of the hydraulic connections, and the free-flowing medium leaves the module again through the other hydraulic connection. This achieves the situation where the free-flowing medium flows through the module or through a plurality of modules preferably connected in series.

As a result of the ability to separate the module carrier (supply of the free-flowing medium) and module (sensor), it becomes possible to remove individual measurement modules and to replace them with new or other modules. If a module is removed, the hydraulic connection between the module and module carrier is separated. As a result, the flow of the free-flowing medium is interrupted at the same time. By means of so-called hydraulic short-circuit elements, which bridge the interruption that has been produced, it is possible to ensure that the apparatus can continue to operate even without the removed module. The short-circuit element restores the flow of the free-flowing medium through the fitting. This permits maintenance work on individual modules or the replacement of modules without the functionality of the overall system being impaired.

The invention further relates to a module carrier system comprising a plurality of module carriers according to the invention, which are or can be reversibly connected mechanically and hydraulically. The hydraulically connected module on a module carrier ensures the flow of the free-flowing medium between two adjacent module carriers. If no module is mounted, a short-circuit element must be used in the module carrier system according to the invention in order to ensure the flow of the free-flowing medium to the module carriers which, in the direction of flow, are connected downstream of the module carrier from which the module has been removed.

As a result of the ability of the module carriers according to the invention to be interconnected, two or more modules which are arranged on adjacent module carriers can be connected hydraulically to each other.

The invention further comprises an assembly of a plurality of module carriers according to the invention. Here, the main surfaces of the various module carriers preferably lie approximately in one plane.

If the module carrier assembly is to be fixed to a wall, only the main surfaces of the first and the last module carrier can lie in one plane, in order to compensate for irregularities and to avoid stresses. The module carrier assembly is then fixed to the wall via these two module carriers, while the main surfaces of the module carriers arranged in between can be arranged in a different plane, offset relative to the wall. Thus, irregularities of the wall can be compensated for without stress arising. Of course, this assumes that the hydraulic and mechanical connection of the module carriers which are offset is appropriately stable, since these module carriers will definitely not be connected to the wall.

In a preferred module carrier assembly according to the present invention, a plurality, preferably all, of the module carriers are arranged in a series circuit.

The invention further comprises a bypass fitting containing one or more module carriers according to the present invention and also a module arranged on this module carrier or modules arranged on these module carriers for the determination and monitoring of parameters of the free-flowing medium or filtering, throttling or blocking devices for the liquid flow, hydraulic short-circuit elements or devices for removing free-flowing medium.

The modules which can be connected to the module carrier according to the invention are subject to no particular restriction per se. It is therefore possible to use modules which can determine and monitor any desired parameters of the free-flowing medium. Furthermore, filtering, throttling or blocking devices for the liquid flow (e.g. shut-off valves), hydraulic short-circuit elements or devices for removing liquid can also be used as modules on the module carriers according to the invention. Appropriate modules are known to those skilled in the art, and they will select and use the modules that are suitable and required in the practical application situation by using their general expertise, so that further explanations are unnecessary at this point.

The module carriers and module carrier systems according to the invention are suitable for the determination and monitoring of properties of any desired free-flowing media. As a result of the modular structure, as compared with the systems known from the prior art, a considerably improved serviceability is achieved. As a result of the ability to remove the modules without impairing the functionality of the overall system (when short-circuit elements are used), the cleaning and the replacement of modules is considerably simplified.

The supply of the fluid medium to the measurement module with the sensor fixed therein can preferably be carried out via an injection nozzle arranged in a connection adapter. The connection adapter can in turn have a bayonet fitting for connection to the measurement module. Thus, it becomes easily possible to remove and clean both the injection nozzle and the sensor from the measurement module. In addition, the cavity in the measurement module is thus accessible for easy cleaning. After the measurement module has been broken down, no cavities remain mechanically unreachable, i.e. all the cavities can be reached, for example with a brush. In addition, easy replacement of the injection nozzle is thus possible in order to adjust the injection angles and the flow rate.

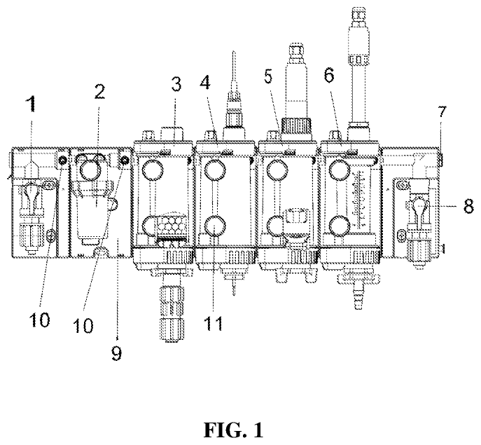

FIG. 1 shows an exemplary fitting comprising module carriers and a module carrier system according to the invention.

Via a hydraulic inlet 1 with a shut-off valve, the free-flowing medium is led (direction of flow from left to right in the plane of the drawing) to a first module carrier 9, which is connected to a particle filter 2 in order to filter out solids from the free-flowing medium. On the side surfaces of the module carrier there are hydraulic connections 10, with which the module carrier 9 can be connected to other module carriers. All further module carriers have corresponding hydraulic connections. Modules 3, 4, 5 and 6 which have two hydraulic connections to the associated module carrier (not shown in the figure) follow in the downward direction. Knurled screws 11 are used for the mechanical connection of the module to the associated module carrier. With the aid of the modules 3 to 6, various parameters of the free-flowing medium or, for example, the volume flow rate of the free-flowing medium can be determined. Additives can be added via a metering valve with a mixing device. A flow limiter is used to adjust the maximum flow, and aeration can be performed via a connection 7. After flowing through the modules 3 to 6 and the flow limiter, the free-flowing medium leaves the system through the hydraulic connection 8 (with shut-off valve). The system is earthed in a suitable way.

### LIST OF REFERENCE SYMBOLS

1 Hydraulic inlet with shut-off valve

2 Particle filter

3 Measurement module

4 Measurement module

5 Measurement module

6 Measurement module

7 Aeration opening

8 Hydraulic connection with shut-off valve

9 Module carrier

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A module carrier for receiving a module having a fluid connection for use in a system for water treatment or water monitoring,
which can be reversibly connected to at least one further module carrier to form a module carrier assembly,
wherein the module carriers can be connected to one another mechanically and detached from one another,
wherein, during the mechanical separation or connection of the module carriers, at least one hydraulic connection between the module carriers can likewise be separated or connected, and
wherein the module carrier is set up for mechanical connection to and separation from the module, wherein, during the mechanical separation and connection of a module from and to its module carrier, at least one hydraulic connection between the module carrier and the module can likewise be separated or connected.

2. The module carrier according to claim 1, wherein the module carrier is designed with a flat outline with a largest-area main surface, and the hydraulic connections are arranged on a side surface adjoining the main surface.

3. The module carrier according to claim 1, wherein the module carrier has a hydraulic connection each on mutually opposite side surfaces.

4. The module carrier according to claim 1, wherein the module carrier, preferably each one of module carriers connected to one another, can be connected to each adjacent module carrier via exactly one hydraulic connection.

5. The module carrier according to claim 1, wherein the hydraulic connection of a module carrier to an adjacent module carrier and/or to a module can be produced without any tools, for example by plugging, a bayonet fitting or a screw closure.

6. The module carrier according to claim 1, having a module, wherein a hydraulic connection between the module carrier and the module is equipped with a sealing device, wherein the sealing device preferably seals as a result of pressure in the connecting direction.

7. The module carrier assembly according to claim 1, wherein a hydraulic connection between two module carriers is equipped with a sealing device, wherein the sealing device preferably seals radially, and/or wherein the sealing device is preferably designed to seal off in various positions in the connection direction of the hydraulic connection.

8. The module carrier assembly according to claim 7, wherein the mechanical connection can be effected by a screw connection, wherein in particular pressure for the sealing device can be generated by the mechanical connection.

9. The module carrier assembly according to claim 8, wherein the module carrier assembly is contained within a bypass fitting and the modules arranged on the module carrier are configured for determining and monitoring parameters of the free-flowing medium or filtering, throttling or blocking devices for the liquid flow, hydraulic short-circuit elements or devices for removing free-flowing medium.
